(19) United States
(12) Patent Application Publication
(10) Pub. No.: US 2007/0027669 A1
(43) Pub. Date: Feb. 1, 2007

(54) System and method for the offline development of passive simulation clients

(75) Inventors: Anthony J. Bybell, Carrboro, NC (US); Kanna Shimizu, Austin, TX (US); Kenneth J. Shiring, Raleigh, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 11/181,468

(22) Filed: Jul. 13, 2005

(51) Int. Cl. G06F 9/45

(52) U.S. Cl. 703/22

(57) ABSTRACT

An improved method and system for development of passive simulation clients includes: running a simulation by a simulator; storing at least a portion of information from the simulation; retrieving the stored information by a simulation proxy; and recreating the simulation by the simulation proxy based on the retrieved information. Full or relevant subset of machine states may be stored in a storage mechanism, which is accessed by the simulation client through the simulation proxy. During code development, instead of accessing the simulator directly, the simulation client code is provided a cycle by cycle view of the simulation model from the storage mechanism as recreated by the simulation proxy. In this manner, development time is quicker as a full simulation environment need not be loaded and run. In addition, machine resources required during client development are reduced drastically.

### FIELD OF THE INVENTION

The present invention relates to the development of passive simulation clients for a network, and more particularly to increasing the efficiency of development of these clients.

### BACKGROUND OF THE INVENTION

The use of passive simulation clients to monitor network performance is known in the art. FIG. 1 illustrates a conventional system of simulation clients. It is desirable to develop the simulation clients 102-104 as software models which monitor and check proper simulation behavior on a cycle by cycle basis without modifying the physical state of the model (e.g., a PCI bus transaction checker). Typically, this requires that the simulation client 102-104 interface directly with a simulator 101 and execute in tandem with the running of the simulation. However, for large simulation models, the simulator 101 must be rerun each time a client interfaces with it, which is time consuming. Also, the running of the simulator 101 may require the use of a simulator license, which may be of a limited number.

Accordingly, there exists a need for an improved method and system for development of passive simulation clients. This method and system should allow for the offline development of simulation clients and provide a quicker development time. The present invention addresses such a need.

### SUMMARY OF THE INVENTION

An improved method and system for development of passive simulation clients includes: running a simulation by a simulator; storing at least a portion of information from the simulation; retrieving the stored information by a simulation proxy; and recreating the simulation by the simulation proxy based on the retrieved information. Full or relevant subset of machine states may be stored in a storage mechanism, which is accessed by the simulation client through the simulation proxy. During code development, instead of accessing the simulator directly, the simulation client code is provided a cycle by cycle view of the simulation model from the storage mechanism as recreated by the simulation proxy. In this manner, development time is quicker as a full simulation environment need not be loaded and run. In addition, machine resources required during client development are reduced drastically.

### BRIEF DESCRIPTION OF THE FIGURES

FIG. 1 illustrates a conventional system of simulation clients.

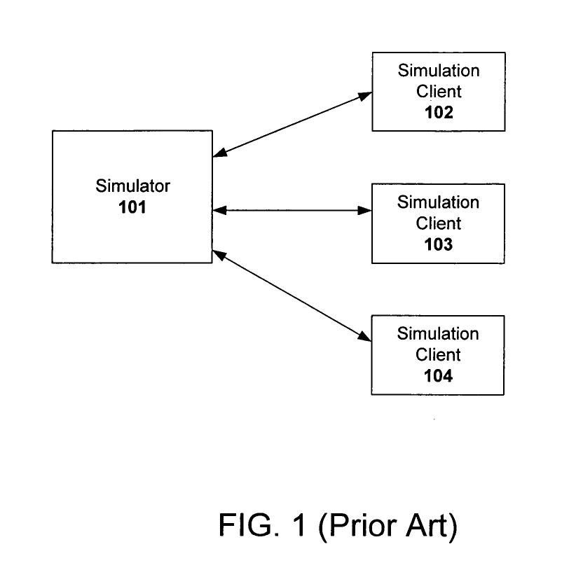

FIG. 2 illustrates a preferred embodiment of a system for development of passive simulation clients in accordance with the present invention.

FIG. 3 is a flowchart illustrating a preferred embodiment of a method for development of passive simulation clients in accordance with the present invention.

### DETAILED DESCRIPTION

The present invention provides an improved method and system for development of passive simulation clients. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

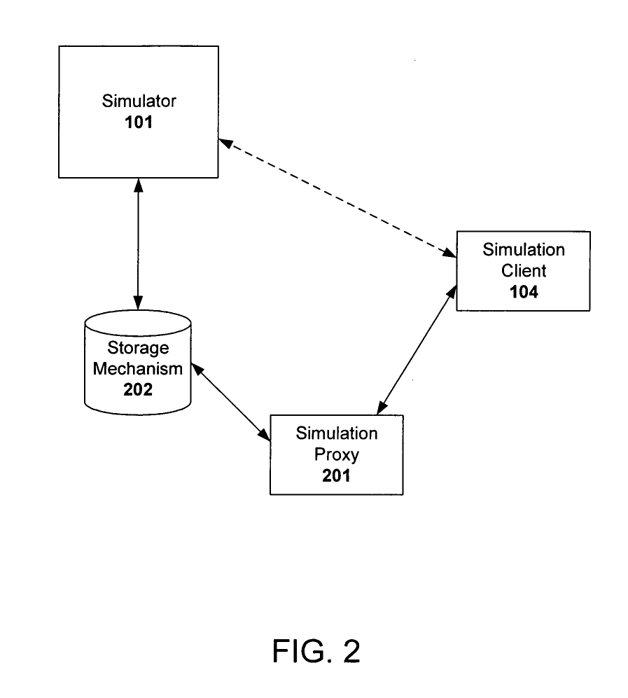

FIG. 2 illustrates a preferred embodiment of a system for development of passive simulation clients in accordance with the present invention. The system includes a simulator 101 for running simulations, a simulation client 104, a simulation proxy 201 for recreating the simulation, and a storage mechanism 202 for storing information concerning the simulation. In the preferred embodiment, the simulator 101 can be a Very High-level Design Language (VHDL) or Verilog simulator.

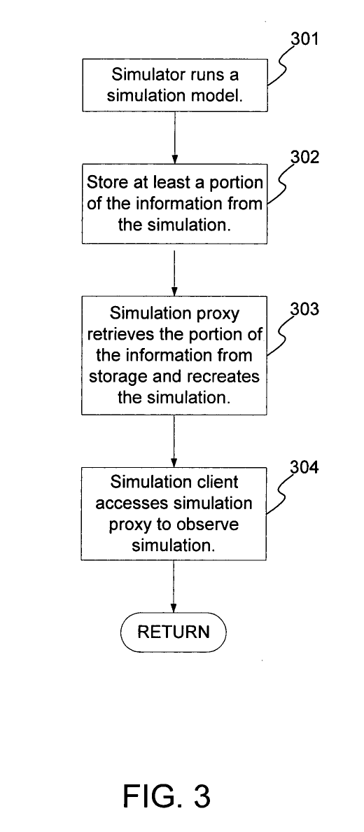

FIG. 3 is a flowchart of a preferred embodiment of a method for development of passive simulation clients in accordance with the present invention. In the preferred embodiment, the method is implemented as software. First, the simulator 101 runs a simulation model, via step 301. Then, information concerning the simulation is stored in the storage mechanism 202, via step 302. In the preferred embodiment, a test case is run once on the simulator 101, and the full or relevant portions of the machines states are dumped into the storage mechanism 202. The storage mechanism 202 can be a file, a database, or some other type of storage mechanism.

The simulation proxy 201 can then retrieve this information from the storage mechanism 202 and recreate the simulation, via step 303. The simulation client 104 then can access the simulation proxy 201 to passively observe the simulation, via step 304. In the preferred embodiment, the simulation proxy 201 reads the machines states on a cycle by cycle (or timestep by timestep) basis from the storage 202 and responds to the queries of the simulation client 104 as if it was itself a simulator. To facilitate ease of use, the application specific interface (API) of the simulation proxy 201 can be similar or equal to that to which the simulation client 104 normally interface. Here, simulation code that is conventionally developed as a simulation client is instead developed as a simulation proxy client. When the simulation client code has completed development, or if it is desired to run against a “live” simulation model, the client code may be executed directly along side the simulator 101 with minimal or no changes, as the API of the simulation proxy 201 is similar or equal to that of the simulator 101.

Optionally, the size of the storage can be reduced if there is an excessive number of unused machine state elements. As the simulation proxy 201 traps the simulation client queries, those queries can be used to create the minimal set of required time-ordered values needed by the simulation client 104 for a particular test case. This minimal set of values is then stored in a database. If a change in the client code causes a “miss” in the database, the database can be queried, a new subset database can be generated, or some other appropriate action can be taken.

An improved method and system for development of passive simulation clients have been disclosed. As the simulation client functions passively, there is no need to continually run simulations in order to obtain the cycle by cycle machine states. Instead, the full or relevant subset of machine states may be stored in a storage mechanism, which is accessed by the simulation client through a simulation proxy. During code development, instead of accessing the simulator directly, the simulation client code is provided a cycle by cycle view of the simulation model from the storage mechanism as recreated by the simulation proxy. In this manner, development time is quicker as a full simulation environment need not be loaded and run. In addition, machine resources required during client development are reduced drastically.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for development of passive simulation clients, comprising:
(a) running a simulation by a simulator;
(b) storing at least a portion of information from the simulation;
(c) retrieving the stored information by a simulation proxy; and
(d) recreating the simulation by the simulation proxy based on the retrieved information.

2. The method of claim 1, further comprising:
(e) observing the recreated simulation by a simulation client.

3. The method of claim 1, wherein the storing (b) comprises:
(b1) storing at least a portion of machines states for the simulation into a storage mechanism.

4. The method of claim 3, wherein the storage mechanism comprises a database or a file.

5. The method of claim 1, wherein the retrieving (c) comprises:
(c1) retrieving machines states for the simulation on a cycle by cycle basis from a storage mechanism.

6. A system, comprising:
a simulator for running a simulation;
a storage mechanism for storing at least a portion of information from the simulation; and
a simulation proxy, wherein the simulation proxy retrieves the information from the storage mechanism and recreates the simulation based on the retrieved information.

7. The system of claim 6, further comprising:
a simulation client, wherein the simulation client observes the recreated simulation.

8. The system of claim 6, wherein the storage mechanism stores at least a portion of machine states for the simulation.

9. The system of claim 6, wherein the storage mechanism comprises a database or a file.

10. The system of claim 6, wherein the simulation proxy retrieves machines states for the simulation on a cycle by cycle basis from the storage mechanism.

11. A computer readable medium with program instructions for development of passive simulation clients, comprising instructions for:
(a) running a simulation by a simulator;
(b) storing at least a portion of information from the simulation;
(c) retrieving the stored information by a simulation proxy; and
(d) recreating the simulation by the simulation proxy based on the retrieved information.

12. The medium of claim 11, further comprising instructions for:
(e) observing the recreated simulation by a simulation client.

13. The medium of claim 1, wherein the storing (b) comprises instructions for:
(b1) storing at least a portion of machines states for the simulation into a storage mechanism.

14. The medium of claim 13, wherein the storage mechanism comprises a database or a file.

15. The medium of claim 11, wherein the retrieving (c) comprises instructions for:
(c1) retrieving machines states for the simulation on a cycle by cycle basis from a storage mechanism.
